(19) United States
(12) Patent Application Publication
(10) Pub. No.: US 2010/0253483 A1
(43) Pub. Date: Oct. 7, 2010

(54) FREIGHT CONTAINER CARGO-WORKING MANAGEMENT SYSTEM AND METHOD USING RFID TECHNOLOGY

(75) Inventors: Hoe-Sung Yang, Daejeon (KR); Dong-Beom Shin, Daejeon (KR); Seung Il Myong, Daejeon (KR); Heyung Sub Lee, Daejeon (KR); Gil Young Choi, Daejeon (KR); Cheol Sig Pyo, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/676,771

(22) PCT Filed: May 23, 2008
(86) PCT No.: PCT/KR2008/002900

§ 371 Date: Mar. 5, 2010

(30) Foreign Application Priority Data
Sep. 5, 2007 (KR) 10-2007-0090041

(51) Int. Cl. H04Q 5/22

(52) U.S. Cl. 340/10.4

(57) ABSTRACT

A freight container cargo-working management system and method which can use Radio Frequency Identification (RFID) technology for displaying a cargo-working location of a container by recognizing an RFID tag adhered to a container vehicle passing through a warehouse entrance is provided. A freight container cargo-working management system including: an RFID tag to include freight information and be adhered to a container; an RFID reader to be installed at a warehouse entrance for recognizing the freight information included in the RFID tag; a cargo-working location information transmitter to be installed at the warehouse entrance for wirelessly transmitting cargo-working location information of the container corresponding to the freight information recognized by the RFID reader; and a cargo-working location display to be included in a vehicle with the container attached for displaying the cargo-working location information wirelessly transmitted from the cargo-working location information transmitter.

This work was supported by the IT R&D program of MIC/IITA [2006-S-023-02, Development of Advanced RFID System Technology].

### TECHNICAL FIELD

The present invention relates to a cargo-working management system and method, and more particularly, to a freight container cargo-working management system and method which can use Radio Frequency Identification (RFID) technology for displaying a cargo-working location of a container by recognizing an RFID tag adhered to a container vehicle passing through a warehouse entrance.

### BACKGROUND ART

Currently, exports and imports using container ships are actively being conducted.

A container is a box-type instrument used for transporting various articles exported and imported via a warehouse or by air.

FIG. 1 illustrates a configuration of a freight container cargo-working management system using a conventional bar code reader.

Referring to FIG. 1, the freight container cargo-working management system using the conventional bar code reader includes a bar code 110 including various freight information, a bar code reader 120 to read the bar code 110, and a location information dispenser 130 to output cargo-working location information 140 of a container 150 based on a reading result of the bar code reader 120.

A cargo-working management procedure for the freight container cargo-working management system using the conventional bar code reader as configured in FIG. 1 is described as follows.

First, when a vehicle 160 transporting the container 150 enters a warehouse entrance, a driver provides a warehouse entrance manager with the bar code 110 having at least one of the vehicle 160 information and driver information of the vehicle 160.

The warehouse entrance manager subsequently determines whether information of the bar code 110 corresponds to predetermined information by reading the bar code 110 using the bar code reader 120. When the information of the bar code 110 corresponds to the predetermined information, the warehouse entrance manager transmits the cargo-working location information 140 to the location information dispenser 130.

The warehouse entrance manager subsequently outputs the cargo-working location information 140 of the container 150 using the location information dispenser 130, and transmits the cargo-working location information 140 of the container 150 to the driver. Here, a cargo-working location of the container 150 is printed in the cargo-working location information 140 of the container 150, and the cargo-working location information 140 of the container 150 corresponds to the reading information.

The driver subsequently transports the container 150 to the cargo-working location.

The cargo-working location may be displayed on a display device to be recognized by the driver instead of being printed.

However, the freight container cargo-working management system using the conventional bar code has a problem that much time is consumed by a procedure of printing and issuing the cargo-working location information after manually recognizing the bar code, and physical distribution is delayed.

Also, when the driver forgets the cargo-working location information displayed on the display device, there is a problem that the freight container cargo-working management system may fail.

FIG. 2 illustrates a configuration of a freight container cargo-working management system using conventional Radio Frequency Identification (RFID) technology.

Referring to FIG. 2, the freight container cargo-working management system using the conventional RFID technology includes an RFID tag 210 to include information about various freights contained within a container 250 and to be adhered to the container 250, an RFID reader 220 to be installed at a warehouse entrance for recognizing the freight information included in the RFID tag 210, and a location information dispenser 230 to print and output a cargo-working location of the container 250 based on the freight information recognized by the RFID reader 220.

A cargo-working management procedure for the freight container cargo-working management system using the conventional RFID technology as configured in FIG. 2 is described as follows.

First, when a vehicle 260, which transports the container 250 to which the RFID tag 210 including various freight information is adhered, passes through the warehouse entrance, the RFID reader 220 wirelessly recognizes the freight information of the RFID tag 210.

The location information dispenser 230 outputs a paper on which cargo-working location information 240 of the container 250 is printed, based on the recognized freight information, and the paper is transferred to the driver.

The cargo-working location information may be displayed on the display device.

While the freight container cargo-working management system using the conventional RFID technology has a convenient vehicle pass procedure, the system has a problem that a vehicle passing through the warehouse entrance is delayed. Also, even when the cargo-working location of the container is displayed on the display device for the driver, there is a problem that the container vehicle is delayed for a predetermined time in the warehouse entrance.

### DISCLOSURE OF INVENTION

### Technical Problem

The present invention provides a freight container cargo-working management system and method which enables a vehicle to quickly pass through a warehouse entrance by wirelessly transmitting a cargo-working location to a display device included in the vehicle and automatically transmitting a cargo-working location of a container to a driver when a container vehicle passes through the warehouse entrance.

### Technical Solution

According to an aspect of the present invention, there is provided a freight container cargo-working management system the system including: a Radio Frequency Identification (RFID) tag to include freight information and be adhered to a container; an RFID reader to be installed at a warehouse entrance for recognizing the freight information included in the RFID tag; a cargo-working location information transmitter to be installed at the warehouse entrance for wirelessly transmitting cargo-working location information of the container corresponding to the freight information recognized by the RFID reader; and a cargo-working location display to be included in a vehicle with the container attached for displaying the cargo-working location information wirelessly transmitted from the cargo-working location information transmitter.

In an aspect of the present invention, the cargo-working location display includes: an

RF receiving module to receive data including the cargo-working location information from the cargo-working location information transmitter; a map database (DB) to include map information of a predetermined area; a display module to display the map information; and a control module to verify, in the map DB, the map information corresponding to the cargo-working location information inputted from the RF receiving module, and control the display module for displaying the map information verified in the map DB.

In an aspect of the present invention, when a Global Positioning System (GPS) device is further included, the cargo-working location display further includes a location information receiving module to receive vehicle location information from the GPS device.

In an aspect of the present invention, the control module controls the display module to provide guidance to a cargo-working location based on the cargo-working location information inputted from the RF receiving module and the map information included in the map DB.

In an aspect of the present invention, when a GPS device is further included, the control module controls the display module to provide guidance to a cargo-working location based on vehicle location information received from the GPS device, the cargo-working location information inputted from the RF receiving module, and the map information included in the map DB.

In an aspect of the present invention, e-seal technology is applied to the RFID tag.

In an aspect of the present invention, the RFID tag is adhered to a lock of the container.

According to another aspect of the present invention, there is provided a freight container cargo-working management method, the method including: recognizing freight information of an RFID tag adhered to a container; transmitting cargo-working location information corresponding to the recognized freight information; and receiving the transmitted cargo-working location information and displaying the received cargo-working location information in a display apparatus installed in a vehicle with the container attached.

### ADVANTAGEOUS EFFECTS

According to the present invention, there is provided a freight container cargo-working management system and method which can provide a quick vehicle pass through a warehouse entrance by automatically transmitting a cargo-working location of a container.

Also, according to the present invention, there is provided a freight container cargo-working management system and method which can conveniently provide a driver of a vehicle transporting a container with a cargo-working location of the container.

### BRIEF DESCRIPTION OF THE DRAWINGS

FIG. 1 illustrates a configuration of a freight container cargo-working management system using a conventional bar code reader;

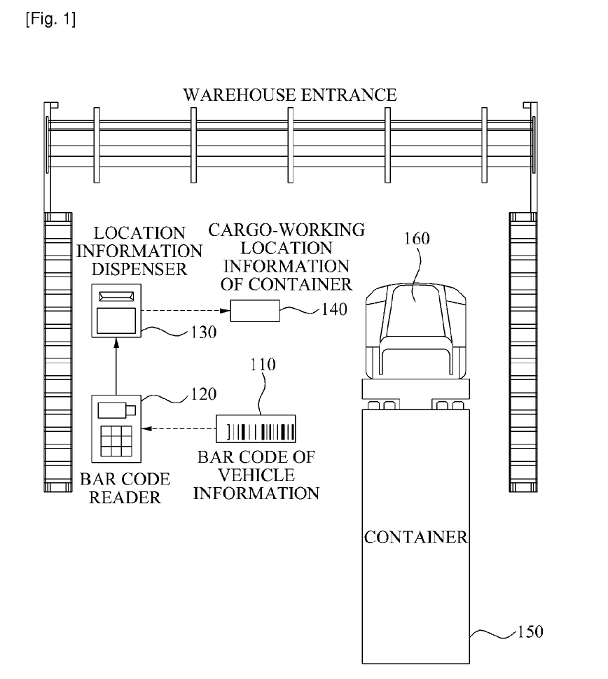

FIG. 2 illustrates a configuration of a freight container cargo-working management system using conventional Radio Frequency Identification (RFID) technology;

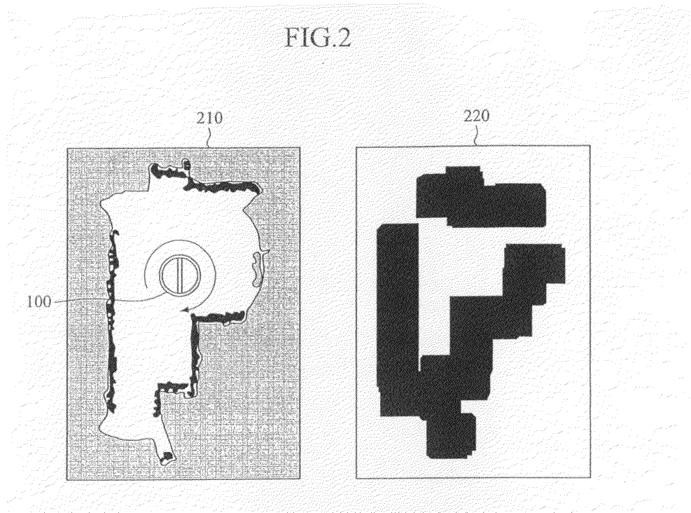

FIG. 3 illustrates a configuration of a freight container cargo-working management system using RFID technology according to an exemplary embodiment of the present invention;

FIG. 4 illustrates a configuration of a cargo-working location display included in the freight container cargo-working management system using the RFID technology according to an exemplary embodiment of the present invention; and

FIG. 5 is a flowchart illustrating a freight container cargo-working management method using the RFID technology according to an exemplary embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

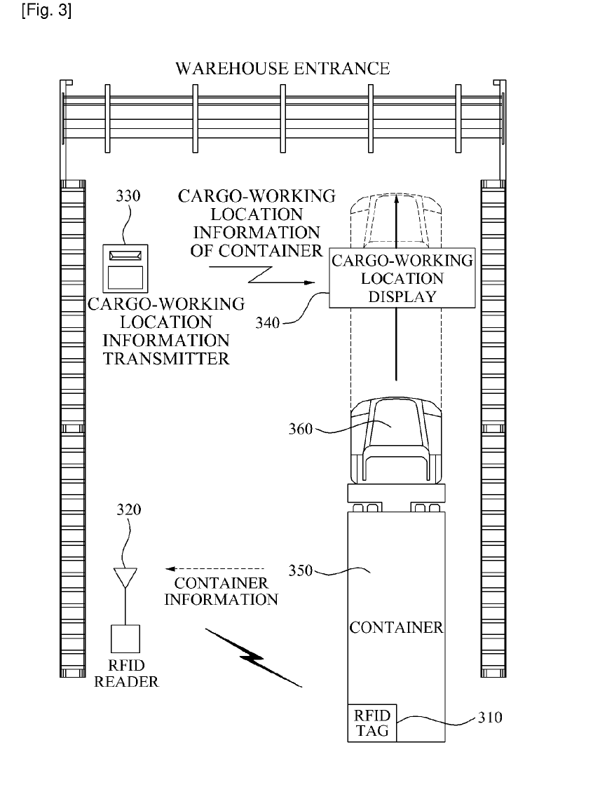

FIG. 3 illustrates a configuration of a freight container cargo-working management system using Radio Frequency Identification (RFID) technology according to an exemplary embodiment of the present invention.

Referring to FIG. 3, the freight container cargo-working management system using the RFID technology according to the present exemplary embodiment of the present invention includes an RFID tag 310 to include freight information and be adhered to a container 350, an RFID reader 320 to be installed at a warehouse entrance for recognizing the freight information included in the RFID tag 310, a cargo-working location information transmitter 330 to be installed at the warehouse entrance for wirelessly transmitting cargo-working location information of the container 350 corresponding to the freight information recognized by the RFID reader 320, and a cargo-working location display 340 to be included in a vehicle 360 with the container 350 attached for displaying the cargo-working location information wirelessly transmitted from the cargo-working location information transmitter 330.

A cargo-working management procedure for the freight container cargo-working management system using the RFID technology according to the present exemplary embodiment of the present invention as configured above is described as follows.

First, when the vehicle 360, which transports the container 350 to which the RFID tag 310 including various freight information is adhered, passes through the warehouse entrance, the RFID reader 320 installed at the warehouse entrance wirelessly recognizes the freight information of the RFID tag 310.

When the cargo-working location information transmitter 330 wirelessly transmit the cargo-working location information to the cargo-working location display 340 included in the vehicle 360 based on the recognized freight information, a driver performs cargo-working of the container 350 after moving to a cargo-working location by recognizing the cargo-working location information of the container 350, the cargo-working location information being displayed on the cargo-working location display 340.

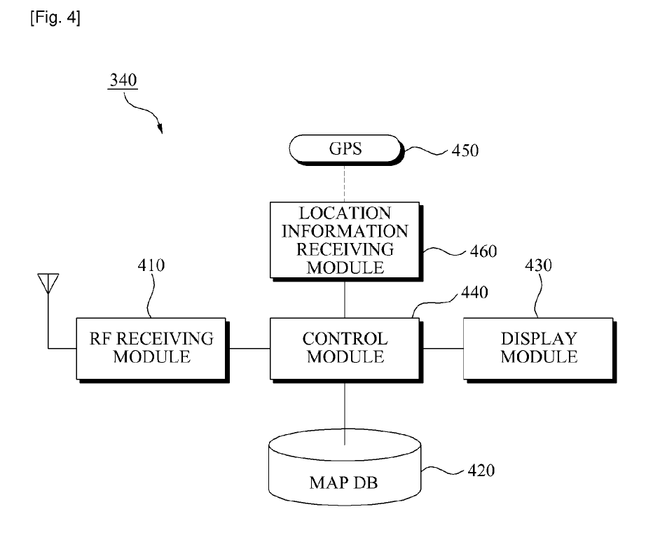

FIG. 4 illustrates a configuration of the cargo-working location display 340 of FIG. 3.

Referring to FIG. 3 and FIG. 4, the cargo-working location display 340 includes an

RF receiving module 410 to receive data including the cargo-working location information of the container 350 from the cargo-working location information transmitter 330, a map database (DB) 420 to include map information of a predetermined area, a display module 430 to display the map information, and a control module 440 to verify, in the map DB 420, the map information corresponding to the cargo-working location information inputted from the RF receiving module 410, and control the display module 430 for displaying the map information verified in the map DB 420.

Also, the freight container cargo-working management system using the RFID technology of the present invention further includes a Global Positioning System (GPS) device 450 installed in the vehicle 360 as required. When the GPS device 450 is further included, the cargo-working location display 340 further includes a location information receiving module 460 to receive vehicle location information from the GPS device 450.

In this instance, the control module 440 controls the display module 430 to provide guidance to the cargo-working location based on the cargo-working location information inputted from the RF receiving module 410, the vehicle location information transmitted from the GPS device 450, and the map information included in the map DB 420. Accordingly, the vehicle 360 may quickly pass through the warehouse entrance and easily transport the container 350 since the driver is automatically guided about the cargo-working location.

Also, RFID e-seal technology developed by a Joint Working Group (JWG) of a freight container technology committee (TC-104) and a packaging technology committee (TC-122) of an International Standardization Organization (ISO) has been recently introduced to the cargo-working management system.

The e-seal technology is a technology of denying an export and an import based on information recorded in the RFID tag when a container door is locked by a lock installed with the RFID tag in order to prevent a random manipulation of an internal freight of the container, and a record of where the lock is opened is stored in the RFID tag.

Accordingly, the RFID tag of the present invention is adhered to the e-sealed lock.

Also, as described above, the cargo-working location display 340 and a GPS module (the GPS device 450 and the location information receiving module 460) may be configured as separate apparatuses, and the GPS module may be further included in the cargo-working location display 340.

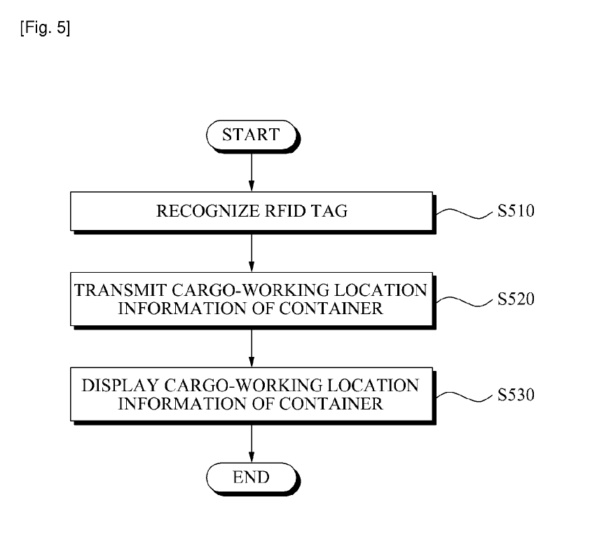

FIG. 5 is a flowchart illustrating a freight container cargo-working management method using the RFID technology according to an exemplary embodiment of the present invention.

Referring to FIG. 5, the freight container cargo-working management method using the RFID technology according to the present exemplary embodiment of the present invention includes recognizing freight information of an RFID tag that includes freight information and is adhered to a container in operation 5510, transmitting cargo-working location information corresponding to the recognized freight information in operation 5520, and receiving the transmitted cargo-working location information and displaying the received cargo-working location information in a display apparatus that is installed in a vehicle with the container attached in operation 5530.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A freight container cargo-working management system, the system comprising:
a Radio Frequency Identification (RFID) tag to include freight information and be adhered to a container;
an RFID reader to be installed at a warehouse entrance for recognizing the freight information included in the RFID tag;
a cargo-working location information transmitter to be installed at the warehouse entrance for wirelessly transmitting cargo-working location information of the container corresponding to the freight information recognized by the RFID reader; and
a cargo-working location display to be included in a vehicle with the container attached for displaying the cargo-working location information wirelessly transmitted from the cargo-working location information transmitter.

2. The system of claim 1, wherein the cargo-working location display comprises:
an RF receiving module to receive data including the cargo-working location information from the cargo-working location information transmitter;
a map database (DB) to include map information of a predetermined area;
a display module to display the map information; and
a control module to verify, in the map DB, the map information corresponding to the cargo-working location information inputted from the RF receiving module, and control the display module for displaying the map information verified in the map DB.

3. The system of claim 2, wherein, when a Global Positioning System (GPS) device is further included, the cargo-working location display further includes a location information receiving module to receive vehicle location information from the GPS device.

4. The system of claim 2, wherein the control module controls the display module to provide guidance to a cargo-working location based on the cargo-working location information inputted from the RF receiving module and the map information included in the map DB.

5. The system of claim 2, wherein, when a GPS device is further included, the control module controls the display module to provide guidance to a cargo-working location based on vehicle location information received from the GPS device, the cargo-working location information inputted from the RF receiving module, and the map information included in the map DB.

6. The system of claim 1, wherein e-seal technology is applied to the RFID tag.

7. The system of claim 1, wherein the RFID tag is adhered to a lock of the container.

8. A freight container cargo-working management method, the method comprising:
recognizing freight information of an RFID tag adhered to a container;
transmitting cargo-working location information corresponding to the recognized freight information; and
receiving the transmitted cargo-working location information and displaying the received cargo-working location information in a display apparatus installed in a vehicle with the container attached.
